(19) United States
(12) Patent Application Publication
(10) Pub. No.: US 2013/0052106 A1
(43) Pub. Date: Feb. 28, 2013

(54) PROCESS FOR THE PRODUCTION OF FERROUS SULPHATE MONOHYDRATE

(71) Applicants: Kim William Gates, Guisborough (GB); Simon Nicholas Roberts, Doncaster (GB)

(72) Inventors: Kim William Gates, Guisborough (GB); Simon Nicholas Roberts, Doncaster (GB)

(73) Assignee: Tioxide Europe Limited, Billiingham, Stockton-on-Tees (GB)

(21) Appl. No.: 13/696,329

(22) PCT Filed: Feb. 11, 2011
(86) PCT No.: PCT/GB2011/050932

§ 371 Date: Nov. 6, 2012

(30) Foreign Application Priority Data
May 17, 2010 (GB) 1008185.9

(51) Int. Cl. C01G 49/14; C22B 3/44

(52) U.S. Cl. 423/146; 423/558

(57) ABSTRACT

The invention provides a process for the production of ferrous sulphate monohydrate which comprises: (a) reacting a source of iron with an aqueous solution of sulphuric acid in at least a first reaction vessel, to obtain a process liquor comprising ferrous sulphate and acid solution; and then (b) combining the process liquor with concentrated sulphuric acid in a mixing vessel, causing the solution to self crystallize, thus forming a slurry comprising crystalline ferrous sulfate monohydrate. The slurry can, if desired, then be converted to ferric sulphate.

The present invention relates to the production of ferrous sulphate monohydrate, which may, in particular, be in the form of a slurry or a solid product, and to the subsequent uses of the ferrous sulphate monohydrate, in particular as a feedstock for producing ferric sulphate.

### BACKGROUND TO THE INVENTION

The process of contacting iron with sulphuric acid to produce ferrous sulphate solution and hydrogen has been well known for many years. The raw materials for such a process are readily available; the iron may be sourced as a relatively pure solid (e.g. steel, usually recycled) or as a chemically bound salt (usually either ferric oxide or ferric sulphate).

GB-A-2 246 561 describes a process for the production of an aqueous solution of ferric sulphate. This involves reacting ferrous sulphate, nitric acid and sulphuric acid, in aqueous solution, to oxidize the ferrous sulphate to ferric sulphate and then completing the oxidation by reacting the residual ferrous sulphate with a peroxide oxidising agent so that the resultant product is substantially free of ferrous ions.

There is therefore a need for a source of ferrous sulphate that can be used in such a process for producing ferric sulphate.

Although highly hydrated ferrous sulphates such as copperas (which has a majority of the heptahydrate FeSO₄.7H₂O) are known, there is a desire for the production of the mono hydrated product. The mono hydrated product has specific uses. These include in agriculture, as an animal feed additive, in horticulture, as an additive for moss killing, and in cement manufacture, for the reduction of Cr⁶⁺ in cement.

### SUMMARY OF THE INVENTION

The present invention provides, in a first aspect, a process for the production of ferrous sulphate monohydrate which comprises:

(a) reacting a source of iron with an aqueous solution of sulphuric acid in at least a first reaction vessel, to obtain a process liquor comprising ferrous sulphate and acid solution; and then

(b) combining the process liquor with concentrated sulphuric acid in a mixing vessel, causing the solution to self crystallize, thus forming a slurry comprising crystalline ferrous sulfate monohydrate.

In a second aspect, the invention provides a method for producing ferric sulphate which comprises carrying out the method of the first aspect and then converting the thus obtained slurry to ferric sulphate.

In a third aspect, the invention provides a method for producing ferric sulphate which comprises carrying out the method of the first aspect, then separating the crystalline ferrous sulfate monohydrate out of the thus obtained slurry, and then converting the thus obtained crystalline ferrous sulfate monohydrate to ferric sulphate.

### DETAILED DESCRIPTION OF THE INVENTION

The source of iron used in the present invention may suitably be solid iron. The source of iron may be steel, in particular scrap steel, but other sources of iron can also be considered, in particular iron ores. Iron ores that can be considered for use include iron rich ores, such as pyrite ash, and iron oxide ores, such as magnetite, hematite, or goethite. Mill scale (ferrous oxide scale from steel manufacturing) may also be considered for use. Mixtures of different sources of iron may be used.

Preferably the source of iron is provided as solid iron in the form of fragments or particles. The surface area of contact and the “conveyability” of the solid iron are the prime considerations. Typically, the particles or fragments would have diameters in the size range of from 5 mm to 35 mm, such as from 10 mm to 30 mm, preferably from 10 mm to 25 mm. As the skilled reader will appreciate, the size of the particles can be determined by using a sieve, or series of sieves, with suitable mesh sizes.

In one embodiment, some or all of the source of iron is provided as solid steel, e.g. in the form of fragments of steel, or in the form of solid iron ore, e.g. in the form of fragments of iron ore.

Some or all of the reaction in step (a) may optionally take place in the presence of ferric (Fe³⁺) ions. In this regard, ferric ions may be provided before the reaction in step (a) commences and/or may be added at any stage during the reaction of step (a). In other words, at any stage before all of the source of iron has been reacted, a source of ferric ions may be added.

The benefit of having ferric ions present, by the addition of a source of ferric ions before or during step (a), is that the reaction will proceed more efficiently. The addition of ferric ions will counteract the effect on the reaction rate of the reduction in acid concentration that will occur during the course of the reaction. Accordingly, the use of ferric ions promotes a high overall rate of production of ferrous sulphate.

Thus some of the iron in the crystalline ferrous sulfate monohydrate may be derived from sources of ferric ions as a starting material, as well as at least some of the iron in the crystalline ferrous sulfate monohydrate being derived from a source of iron, in particular solid iron (such as steel or iron ore) as a starting material.

Preferably 25 at % (atomic percent) or more of the iron in the crystalline ferrous sulfate monohydrate is derived from the source of iron (e.g. steel), e.g. 30 at % or more, more preferably 32 at % or more, e.g. 33 at % or more, most preferably 34 at % or more, such as from 34 to 100 at %. Preferably from 0 to 66 at % of the iron in the crystalline ferrous sulfate monohydrate is derived from sources of ferric ions (e.g. ferric compounds).

In one embodiment 95 at % or more, such as 99 at % or more, of the iron in the crystalline ferrous sulfate monohydrate is derived from the source of iron (e.g. steel) and the sources of ferric ions (e.g. ferric compounds). Most preferably, all of the iron in the crystalline ferrous sulfate monohydrate is derived from the source of iron (e.g. steel) and the sources of ferric ions (e.g. ferric compounds).

Ferric ions may be provided by the addition of ferric compounds in the form of chemically bound iron salts. For example, ferric oxide or ferric sulphate may be added. In this regard, the ferric compounds may have a mill scale of from 0% to 66% solid. The ferric compounds can be digested by the sulphuric acid present in step (a).

Alternatively or additionally, ferric ions may be provided by adding a ferric ion solution in step (a), for example a ferric sulphate solution may be added in step (a).

Alternatively or additionally, a ferric compound may be reacted with acid and this digested ferric species can then be added in step (a). In particular, a ferric compound, such as ferric oxide, may be reacted with sulphuric acid to generate ferric sulphate (Fe₂(SO₄)₃) and this can then be added in step (a). This generated ferric sulphate may, optionally, be added together with some or all of the sulphuric acid to be used in step (a).

It may be that the source of iron is provided to the first reaction vessel in step (a) together with ferric compounds, for example in step (a) a mixture of steel and dry ferric compounds may be added to the first reaction vessel. The ferric compounds can be added in a controlled manner to produce a consistent blend of iron compounds feeding the reaction.

The source of iron may be fed continuously, or semi-continuously (i.e. generally continuously but with some pauses; e.g. such that 75% or more of the time the source of iron is being fed continuously), or batch wise (i.e. discontinuously) into the first reaction vessel. Any suitable feed mechanism for feeding the source of iron into the first reaction vessel may be used, e.g. it may be selected from a screw conveyor, a belt conveyor and a vibrating conveyor. The form in which the iron is provided may influence the choice of feed mechanism. The conveyor may transfer the source of iron to a feed chute which leads into the first reaction vessel.

In one embodiment, the source of iron is provided as solid steel or solid iron ore in the form of fragments or particles that are conveyed, preferably continuously, into the first reaction vessel using a belt conveyor or vibrating conveyor.

The aqueous solution of sulphuric acid that is used in the first reaction vessel in step (a) suitably has a concentration of 5% wt/wt or higher, in particular from 5% to 50% wt/wt, preferably from 5% to 45% wt/wt, such as from 10% to 40% wt/wt or from 20 to 40% wt/wt. The aqueous solution of sulphuric acid may suitably be circulated at high rate through the first reaction vessel, as discussed further below.

The source of iron and the aqueous solution of sulphuric acid may be provided in the first reaction vessel in stoichiometric amounts or there may be an excess of the aqueous solution of sulphuric acid or there may be an excess of the source of iron. In one embodiment there is an excess of the aqueous solution of sulphuric acid.

The reaction vessel is initially charged with the source of iron and the aqueous solution of sulphuric acid; further quantities of the source of iron may be added to the first reaction vessel as it is consumed, as required. In one embodiment, from 1 to 3 tonnes, e.g. approximately 2 tonnes, of the source of iron, e.g. steel, is used in the first reaction vessel. The skilled reader will appreciate that an amount of the source of iron should be selected to ensure sufficient reaction surface area.

In one embodiment, the first reaction vessel is used in combination with a first circulation tank. In this regard, the aqueous solution of sulphuric acid may be circulated from the first circulation tank to the first reaction vessel to react with the source of iron. Preferably, the aqueous solution of sulphuric acid is circulated from the first circulation tank to the first reaction vessel and back to the first circulation tank at least once. In one embodiment, the aqueous solution of sulphuric acid is circulated from the first circulation tank to the first reaction vessel and back to the first circulation tank only once. In another embodiment, the aqueous solution of sulphuric acid is circulated from the first circulation tank to the first reaction vessel and back to the first circulation tank two or more times.

Preferably, the aqueous solution of sulphuric acid is circulated from the first circulation tank to the first reaction vessel and back to the first circulation tank using one or more pumps, such as high capacity pumps.

Typically the flow rate for the aqueous solution of sulphuric acid would be from 250 to 450 m³/hr, preferably from 300 to 400 m³/hr, such as about 300 or about 350 m³/hr. As the skilled man would appreciate, a suitable flow rate can be determined by the design of the reaction vessel and will be influenced by the fluidisation velocity of the source of iron that is added and diameter of the reactor.

In one embodiment, the source of iron is provided in the form of fragments or particles of solid iron (such as steel fragments), optionally together with particles of ferric compounds, and the aqueous solution of sulphuric acid is fed into the first reaction vessel to produce a fluidised bed of the solid iron within the reaction vessel. For example, this may be achieved by feeding the aqueous solution of sulphuric acid through a distribution plate at the bottom of the first reaction vessel. This is a beneficial arrangement for allowing the reaction to take place between the iron and the sulphuric acid.

The process liquor comprising ferrous sulphate and acid solution that is generated in the first reaction vessel may be fed to the first circulation tank.

Due to the generation of hydrogen within the reaction vessel it is important to ensure there is a route provided for removal of the hydrogen. Agitation of the liquid components allows for effective evolution of the hydrogen. Hydrogen that evolves is preferably allowed to separate from the liquid components in the first reaction vessel and can then be collected under partial vacuum. The hydrogen thus collected can be diluted with air and vented at a safe location. Alternatively, the hydrogen may be collected in a sealed environment for purification. This may involve it being scrubbed to remove impurities (such as acid droplets) and then separated and purified for compression. The exact choice of which route is used depends upon the economics of the installation and the revenue that could be generated by the sale of the purified hydrogen.

In one embodiment, the reaction of the source of iron with the aqueous solution of sulphuric acid is carried out only in a single reaction vessel (the first reaction vessel). In an alternative embodiment, the reaction of the source of iron with the aqueous solution of sulphuric acid is carried out in more than one reaction vessel (the first reaction vessel together with an additional reaction vessel or a plurality of additional reaction vessels).

Accordingly, at any stage before the reaction has been progressed as far as is required (in particular at any stage before the reaction of the starting materials has completed, e.g. at any stage before the source of iron has been entirely reacted) some or all of the reaction materials (unreacted starting materials plus process liquor) from the first reaction vessel can be transferred to an additional reaction vessel. These materials may be transferred either directly or indirectly from the first reaction vessel. In one embodiment, the materials are transferred via the first circulation tank.

Further quantities of the source of iron may be added to the additional reaction vessel as required. In the event that there is more than one additional reaction vessel, further quantities of the source of iron may be added to each additional reaction vessel as required. The skilled reader will appreciate that an amount of the source of iron should be selected to ensure sufficient reaction surface area.

In one embodiment, from 1 to 3 tonnes, e.g. approximately 2 tonnes, of the source of iron e.g. steel, is used in the first additional reaction vessel and optionally in each further additional reaction vessel.

In one embodiment, ferric ions are provided in the additional reaction vessel. In the event that there is more than one additional reaction vessel, ferric ions may be provided in some or all of these vessels; in one embodiment ferric ions are provided in at least the first additional reaction vessel.

The addition of ferric ions is advantageous in terms of the reaction efficiency, as the presence of ferric ions will counteract the effect on the reaction rate that is caused by the reduced acid concentration in the additional reaction vessel as compared to the first reaction vessel, which is caused by the reaction of the acid with the source of iron. Generally, any additional reaction vessel may have an acid concentration that is at least 5% (wt/wt) less than that in the first reaction vessel, such as at least 10% (wt/wt) less, or at least 15% (wt/wt) less.

The ferric ions may be provided by a source of ferric ions being added to the additional reaction vessel. This may be before the addition of the reaction materials from the first reaction vessel, together with the reaction materials from the first reaction vessel, or after the addition of the reaction materials from the first reaction vessel.

Ferric ions may be provided by the addition of ferric compounds in the form of chemically bound iron salts, for example ferric oxide or ferric sulphate.

Alternatively or additionally, ferric ions may be provided by adding a ferric solution, for example a ferric sulphate solution may be added to the additional reaction vessel.

Alternatively or additionally, a ferric compound may be reacted with acid and this digested ferric species can then be added to the additional reaction vessel. In particular, a ferric compound, such as ferric oxide, may be reacted with sulphuric acid to generate ferric sulphate (Fe₂(SO₄)₃) and this can then be added to the additional reaction vessel.

In one embodiment, ferric ions are provided by combining a dry ferric product with the reaction materials from the first reaction vessel. The addition of this dry product generates ferric ions due to the formation of aqueous ferric sulfate. In one embodiment, the dry ferric product may be provided in the additional reaction vessel and the reaction materials may flow into this reaction vessel and thus contact the ferric product. In another embodiment, the dry ferric product may be added to the additional reaction vessel after the reaction materials have passed into the additional reaction vessel.

Typically, the ferric ions would be provided by the use of mill scale from steel manufacturing. Alternatively, iron oxide could be used, depending upon cost and availability.

In one embodiment, the additional reaction vessel is used in combination with an additional circulation tank. In this regard, the reaction materials from the first reaction vessel may be circulated to the additional circulation tank and then from the additional circulation tank to the additional reaction vessel, where they may be reacted with ferric ions. Alternatively, however, the reaction materials from the first reaction vessel may be circulated to the additional reaction vessel, where they may be reacted with ferric ions, without going via the additional circulation tank.

Preferably, the reaction materials are circulated from the additional reaction vessel to the additional circulation tank at least once. In one embodiment, the reaction materials are circulated from the additional reaction vessel to the additional circulation tank only once. In another embodiment, the reaction materials are circulated from the additional reaction vessel to the additional circulation tank two or more times.

It is preferred that the reaction materials from the first reaction vessel are circulated to the additional circulation tank (optionally via the first circulation tank) and then on to the additional reaction vessel. Accordingly, the reaction materials are preferably circulated from the additional circulation tank to the additional reaction vessel and back to the additional circulation tank at least once. In one embodiment, the reaction materials are circulated from the additional circulation tank to the additional reaction vessel and back to the additional circulation tank only once. In another embodiment, the reaction materials are circulated from the additional circulation tank to the additional reaction vessel and back to the additional circulation tank two or more times.

Preferably, the reaction materials are circulated from the additional circulation tank to the additional reaction vessel and back to the additional circulation tank using one or more pumps, such as high capacity pumps.

In one embodiment, there is only one additional reaction vessel, within which the reaction of step (a) is completed to a desired extent (such as until the reaction of the starting materials has completed, e.g. until the source of iron has been entirely reacted). The reaction in the additional reaction vessel is optionally in the presence of ferric ions.

However, in an alternative embodiment there are two or more additional reaction vessels, i.e. the additional reaction vessel referenced above is a first additional reaction vessel and there is a second additional reaction vessel (and optionally further additional reaction vessels). In such an embodiment some or all of the reaction materials (unreacted starting materials plus obtained process liquor) from the first additional reaction vessel are transferred to the second additional reaction vessel. In one embodiment, ferric ions are optionally provided in the second additional reaction vessel. This may be as described above with reference to the additional reaction vessel.

This stage involving further reaction vessels and optional provision of ferric ions may be repeated as required. For example, there may be transfer from the second additional reaction vessel to a third additional reaction vessel, with optional contact with ferric ions, and optionally there may be transfer from the third additional reaction vessel to a fourth additional reaction vessel, with optional contact with ferric ions.

The arrangements for any additional reaction vessels subsequent to the first additional reaction vessel may suitably be the same as for the first additional reaction vessel, except that the transfer of reaction materials will of course be from the preceding additional vessel/additional circulation tank rather than from the first reaction vessel/circulation tank.

The one or more additional reaction vessels are suitably used to reduce the acid strength of the process liquor as obtained in the first reaction vessel.

In one embodiment, the one or more additional reaction vessels are used to reduce the acid strength of the process liquor by an amount of 5% (wt/wt) or more, such as 10% (wt/wt) or more, or 15% (wt/wt) or more.

In the event that the acid strength of the process liquor obtained in the first reaction vessel is sufficiently low, the use of one or more additional reaction vessels is not necessary, although it may still be carried out if desired.

In one embodiment, the acid strength of the process liquor obtained at the end of step (a) is from 0 to 20% (wt/wt), preferably from 0 to 15% (wt/wt), such as from 1 to 12% (wt/wt), e.g. from 5 to 10% (wt/wt).

As compared to the reaction in the first reaction vessel, the reaction in the (or each) additional reaction vessel will have a slower reaction rate. The (or each) subsequent reaction stage brings the reactants to the desired acid concentration.

However, the reaction with ferric ions is used to counteract the effect of a reducing acid concentration on the reaction rate. Accordingly, the use of ferric ions promotes a sufficiently high overall rate of production of ferrous sulphate.

The rate of flow between a given pair of one reaction vessel and its corresponding circulation tank (circulation rate) is preferably higher than the rate of flow from any given pair of one reaction vessel and its corresponding circulation tank to the next pair of one reaction vessel and its corresponding circulation tank (transfer rate).

Typically a circulation rate (between one reaction vessel and its corresponding circulation tank) is from 250 to 450 m³/hr, preferably 300 to 400 m³/hr, such as about 350 m³/hr. The transfer rate (rate of flow for the transfer from any given pair of one reaction vessel and its corresponding circulation tank to the next pair of one reaction vessel and its corresponding circulation tank) could suitably be from 10 to 70 m³/hr, preferably from 20 to 60 m³/hr, such as from 30 to 50 m³/hr.

In step (a)—in the first reaction vessel and any additional reaction vessels—the temperature of the process is controlled to promote solubility of ferrous sulphate. This is in order to achieve a suitably high degree of solubility for the ferrous sulphate generated during the reactions in the reaction vessels such that the ferrous sulphate does not precipitate out. This may, for example, be achieved with the use of a cooling system within the circulation tanks. The temperature may be controlled to be from 20° C. to 100° C., such as from 30° C. to 90° C. and preferably from 35° C. to 85° C., more preferably from 40° C. to 80° C., such as from 50° C. to 70° C.

After step (a) the generated acidic ferrous sulphate solution may have a concentration of ferrous sulphate of from 5 to 25% (wt/wt), such as from 5 to 20% (wt/wt), e.g. from 7 to 15% (wt/wt) or from 8 to 12% (wt/wt).

The process liquor may be treated before step (b) in order to remove unwanted solids. For example, before step (b) the process liquor may be filtered to remove solids such as detritus and unreacted solid material. This may be achieved using a sieve, such as a vibrating sieve. Any unreacted material separated at this stage may be returned to step (a). Any detritus separated at this stage may be washed and disposed of according to appropriate waste management regulations.

Step (b) is carried out in a mixing vessel. This may be any vessel within which the process liquor can be mixed with concentrated sulphuric acid; the mixing vessel may be any desired shape and size. It may, for example, be a conventional mixing drum or vat but may equally be a pipe within which the process liquor may be flowing. It potentially could be one of the aforementioned reaction vessels.

The process liquor obtained in step (a), having optionally been treated to remove unwanted solids, can be transported, for example by pumping, to the mixing vessel in step (b).

In one embodiment, the acid strength of the process liquor used in step (b) is from 0 to 20% (wt/wt), preferably from 0 to 15% (wt/wt), such as from 1 to 12% (wt/wt), e.g. from 5 to 10% (wt/wt).

In step (b) the process liquor is combined with concentrated sulphuric acid. The dilution of the concentrated sulphuric acid acts firstly to heat the solution and secondly to increase the acid strength of the process liquor. The combination of these effects significantly reduces the solubility of ferrous sulphate, causing the solution to self crystallize to form ferrous sulfate monohydrate FeSO₄.H₂O.

The increase in the acid strength of the process liquor caused by the addition of acid may be an increase of 5% (wt/wt) or more, such as 10% (wt/wt) or more, or 15% (wt/wt) or more.

The concentrated sulphuric acid used in step (b) may suitably have a concentration of 90% (wt/wt) or higher—e.g. from 90 to 98% (wt/wt)—such as a concentration of 95% (wt/wt) or higher, e.g. from 95 to 98% (wt/wt).

In step (b) the temperature before the process liquor is combined with concentrated sulphuric acid is preferably from 35 to 85° C., more preferably from 40 to 80° C., most preferably from 60 to 80° C. The use of such initial temperatures (which are then raised by the dilution of the concentrated sulphuric acid) favours the formation of the monohydrate crystalline form of ferrous sulphate (FeSO₄.H₂O).

In step (b) control of the acid strength and temperature of the mixture ensures the formation of the monohydrate crystal.

In step (b) the process liquor is suitably combined with concentrated sulphuric acid to give a concentration of acid in the mixing vessel of 15% to 50% (wt/wt), preferably from 15% to 45% (wt/wt), more preferably from 35% to 45% wt/wt. The use of such concentrations favours the formation of the monohydrate crystal (FeSO₄.H₂O).

In one embodiment, in step (b) from 20 to 40 m³/hr of process liquor is combined with from 400 to 800 litres/hour of concentrated sulphuric acid. For example, from 25 to 35 m³/hr of process liquor may be combined with from 500 to 700 litres/hour of concentrated sulphuric acid. Suitable amounts can, however, be selected by the skilled reader taking into account factors such as reaction rate.

The product of step (b) is a slurry comprising crystallized ferrous sulfate. The slurry also comprises any remaining soluble ferrous sulfate in acid solution.

The product of step (b) may subsequently be thickened, to generate a slurry with a higher Fe concentration.

Accordingly, in one embodiment of the invention, the process further comprises:
(c) thickening the slurry comprising crystalline ferrous sulfate monohydrate to increase the concentration of ferrous sulfate in the slurry.

Step (c) can be achieved by any suitable technique for thickening slurries, such as gravity settling, or the use of a hydrocyclone, or the use of a centrifuge.

The thickening of the slurry will involve removal of liquid from the slurry. This liquid will be acidic. The acidic liquid generated (e.g. the overflow from the gravity thickener or hydrocyclone) may be recycled to be used as aqueous solution of sulphuric acid in step (a). It may of course be diluted or concentrated before such use, as required.

The thickened slurry generated in step (c) preferably has a concentration of 15% (wt/wt) or more of ferrous sulfate monohydrate crystal, such as 20% (wt/wt) or more; preferably the slurry has a concentration of from 20% to 40% (wt/wt) of ferrous sulfate monohydrate crystal.

The slurry generated in step (b) or the thickened slurry generated in step (c) can be used as a slurry in suitable applications.

In one embodiment the method further comprises the step of:
(d1) adjusting the slurry to have a desired set of characteristics in terms of Fe concentration, acid concentration and/or water content.

In this regard, the slurry may be thickened and/or diluted to achieve desired characteristics. These may be characteristics relating to Fe concentration, acid concentration and water content to allow the slurry to be used as the feedstock for conversion to ferric sulphate (e.g. using the process as described in GB-A-2 246 561).

In this regard, the slurry may, for example, be adjusted so as to have a total Fe²⁺ concentration from 15% to 25% wt/wt, such as from 20 to 25% wt/wt. The acid concentration of the slurry may also be adjusted, e.g. to be no greater than 15%, such as from 5 to 10% (wt/wt). The water content of the slurry may also be adjusted to be, for example, 40% or less, such as from 10 to 40% (wt/wt), e.g. it may be adjusted to be 35% or less, such as from 15 to 35% (wt/wt).

The slurry may need to be thickened significantly and then diluted with fresh water in order to control the acid strength.

The thickening and dilution techniques that can be used to achieve desired characteristics relating to Fe concentration, acid concentration and water content are known to the skilled man.

Suitably, the slurry is firstly thickened to the point where the desired acid concentration is achieved. Then the thickened slurry is diluted with water to achieve the desired iron content. Thickening could be achieved with a sedimentation device (e.g. gravity settler or centrifuge) with dilution on discharge or by use of a filter with repulper.

The slurry as obtained from any of steps (b), (c) or (d1)—but particularly suitably from step (d1)—may be used as the feedstock for conversion to ferric sulphate.

Accordingly, in one embodiment, the method comprises step (d1) and the following step:
(e1) converting the slurry to ferric sulphate.

The conversion to ferric sulphate may be via any suitable technique, for example as described in GB-A-2 246 561.

Alternatively, the slurry generated in step (b) or the thickened slurry generated in step (c) or the adjusted slurry as generated in step (d1) can be converted to a solid monohydrate product.

Accordingly, in another embodiment the method further comprises the step of:
(d2) separating the crystalline ferrous sulfate monohydrate out of the slurry.

This step (d2) may be carried out after step (b) or after step (c) or after step (d1).

In this regard, the slurry may suitably be filtered to obtain a residue that comprises solid ferrous sulfate monohydrate product.

The filtrate will be acidic. The acidic filtrate may therefore be recycled to be used as aqueous solution of sulphuric acid in step (a). It may of course be diluted or concentrated before such use, as required.

The solid ferrous sulfate monohydrate product obtained as the residue may, for example, have an acid content of 10% or less, such as from 5 to 10%, or it may be 5% or less, such as from 2 to 5% (wt/wt). It may have a water content of 15% or less, such as from 0 to 13% (wt/wt). It may have a ferrous sulfate monohydrate content of, for example, 80% or more, such as from 85 to 95% (wt/wt).

The separated crystalline ferrous sulfate monohydrate product may be conveyed to storage.

This separated solid ferrous sulfate monohydrate product can be used as the feedstock for the production of ferric sulphate.

Accordingly, in one embodiment, the method comprises step (d2) and the following step:
(e2) converting the ferrous sulfate monohydrate product to ferric sulphate.

The separated solid ferrous sulfate monohydrate product can be dried and/or neutralized. The product is suitably obtained as a neutralized, relatively free flowing product.

In one embodiment the separated solid ferrous sulfate monohydrate product may be dried. The drying of the crystalline ferrous sulfate monohydrate product may be chemical (by adding a drying agent, such as powdered limestone) or thermal (by heating the product to a suitable temperature).

Alternatively or additionally, the separated solid ferrous sulfate monohydrate product may be neutralized. In particular, the separated solid ferrous sulfate monohydrate product may be blended with a neutralizing agent, such as limestone. Preferably the neutralizing agent is dry. More preferably the neutralizing agent also acts as a drying agent. In one preferred embodiment the neutralizing agent is powdered limestone. Other neutralizing agents that can be mentioned include sepiolite, magnesium carbonate and zeolites.

Accordingly it may be that the separated solid ferrous sulfate monohydrate product is blended with an amount of neutralizing agent, such as powdered limestone, to produce a neutralized, relatively free flowing product. Any suitable amount of neutralizing agent may be used, e.g. 1 wt % or more of neutralizing agent may be added to the separated solid ferrous sulfate monohydrate product. Generally from 2 wt % to 10 wt % of neutralizing agent would be added to the separated solid ferrous sulfate monohydrate product.

Accordingly, in one embodiment, the method comprises step (d2) and the following step:
(e3) neutralizing and/or drying the ferrous sulfate monohydrate product, for example by the addition of a neutralizing agent, such as powdered limestone.

In a second aspect, the invention provides a method for producing ferric sulphate which comprises carrying out the method of the first aspect and then converting the slurry thus obtained to ferric sulphate. The slurry may be as obtained from any of steps (b), (c) or (d1), but preferably from step (d1).

In a third aspect, the invention provides a method for producing ferric sulphate which comprises carrying out the method of the first aspect and then separating the crystalline ferrous sulfate monohydrate out of the slurry and then converting the crystalline ferrous sulfate monohydrate thus obtained to ferric sulphate.

In either of the second and third aspects, the conversion to ferric sulphate may be via any suitable technique, for example as described in GB-A-2 246 561.

### EXAMPLE

Stage 1

Solid iron in the form of scrap steel was continuously fed as small fragments via a belt into a feed chute which discharged into a first reaction vessel. Dry ferric compounds (ferric oxide or ferric sulphate) were added to the conveying system in a controlled manner to produce a consistent blend of iron compounds feeding the reaction.

An aqueous solution of about 35% wt/wt sulphuric acid was provided in a first circulation tank and circulated into the reaction vessel in order to contact the acid with the iron. Above stoichiometric amounts of acid were added, with about 300 m³/hr of the acid being circulated around about 2 tonnes of scrap steel.

The process liquor was circulated around the reaction vessel from the circulation tank using high capacity pumps, and fed through a distribution plate at the bottom of the reaction vessel to produce a fluidised bed of iron/iron compound particles within the reaction vessel, allowing the reaction to take place between the iron and sulphuric acid. The liquor was then returned to the circulation tank.

The liquid in the reaction vessel was agitated to allow the hydrogen evolved from the process to separate from the liquid in the reaction vessel. The hydrogen was then collected under partial vacuum. The temperature in the vessels was controlled to be from 50° C. to 70° C.

Stage 2

The liquor from the circulation tank of the first stage was passed into the circulation tank of the second stage. It was then circulated into a second reaction vessel where it was contacted with ferric ions, provided by the addition of a low-grade dry ferric product. The temperature in the vessels was controlled to be from 50° C. to 70° C.

Once a low acid strength aqueous solution (between 0% & 20% (wt/wt) sulphuric acid) was obtained, the liquor was an acidic ferrous sulphate solution that could be used in the next stage.

Stage 3

The acidic ferrous sulphate solution was filtered using a vibrating sieve to remove detritus & unreacted solid material. The filtered ferrous sulphate solution was then transported, using an export pump, to the next stage of the process.

Stage 4

The filtered, slightly acidic, ferrous sulphate solution was combined with a stream of concentrated sulphuric acid (from 95 to 98 (wt/wt)) in a mixing tank. The temperature before the acidic ferrous sulphate solution was combined with the concentrated sulphuric acid was in the range of 60 to 80° C. The acidic ferrous sulphate solution was combined with the concentrated sulphuric acid to give a concentration of acid in the mixing vessel in the range 15% to 45% (wt/wt). The dilution of the concentrated sulphuric acid acted firstly to heat the solution and secondly to increase the acid strength of the process liquor. This caused the liquor to self crystallize, forming ferrous sulfate monohydrate FeSO₄.H₂O. The resulting slurry, containing both crystallized and soluble ferrous sulfate, was then transferred to the next stage of the process.

Stage 5

The slurry was thickened to generate a high Fe concentration slurry using a gravity thickener. The clarified acidic liquor generated as the overflow from the gravity thickener was used as acidic feedstock to the first circulation tank in stage 1.

Stage 6

The thickened slurry was filtered to produce a solid monohydrate product. The filtrates were recycled back to stage 1 of the process.

Results—Run A

The thickened slurry had from 20% to 40% by wt. monohydrate crystal. The end product obtained was 25-28% Fe (II), 28-30% total Fe and approx 5% -10% sulphuric acid. The particle size range of the obtained product was approximately 20 μm-55 μm.

Results—Run B

The thickened slurry had from 24% to 27% by wt. monohydrate crystal. The end product obtained was 28-32% Fe (II), and approx 2% -5% sulphuric acid.

1. A process for the production of ferrous sulphate monohydrate which comprises:
(a) reacting a source of iron with an aqueous solution of sulphuric acid in at least a first reaction vessel, to obtain a process liquor comprising ferrous sulphate and acid solution; and then
(b) combining the process liquor with concentrated sulphuric acid in a mixing vessel, causing the solution to self crystallize, thus forming a slurry comprising crystalline ferrous sulfate monohydrate.

2. The process of claim 1 wherein the source of iron is provided as solid iron in the form of steel or an iron ore.

3. The process of claim 1 wherein the aqueous solution of sulphuric acid that is used in the first reaction vessel has a concentration of from 5% to 50% wt/wt.

4. The process of claim 3 wherein the aqueous solution of sulphuric acid that is used in the first reaction vessel has a concentration of from 35% to 45% wt/wt.

5. The process of claim 1 wherein 25 at % or more of the iron in the crystalline ferrous sulfate monohydrate is derived from the source of iron as starting material.

6. The process of claim 5 wherein from 34 to 100 at % of the iron in the crystalline ferrous sulfate monohydrate is derived from the source of iron as starting material.

7. The process of claim 1 wherein some or all of the reaction in step (a) takes place in the presence of ferric ions.

8. The process of claim 7 wherein from 0 to 66 at % of the iron in the crystalline ferrous sulfate monohydrate is derived from sources of ferric ions.

9. The process of claim 7 wherein all of the iron in the crystalline ferrous sulfate monohydrate is derived from sources of ferric ions and the source of iron as starting material.

10. The process of claim 7 wherein ferric ions are provided by: the addition of ferric compounds in the form of chemically bound iron salts, and/or by adding a ferric solution and/or by reacting a ferric compound with acid and adding this digested ferric species.

11. The process of claim 1 wherein during step (a) the temperature of the process is controlled to be from 35° C. to 85° C.

12. The process of claim 1 wherein in step (b) the process liquor has a concentration of acid of from 0 to 15% wt/wt before it is combined with the concentrated sulphuric acid.

13. The process of claim 1 wherein in step (b) the temperature of the process liquor before it is combined with concentrated sulphuric acid is from 35 to 85° C.

14. The process of claim 1 wherein the concentrated sulphuric acid used in step (b) has a concentration of 90% wt/wt or higher.

15. The process of claim 1 wherein in step (b) the process liquor is combined with concentrated sulphuric acid to give a resultant concentration of acid in the mixing vessel of from 15% to 50% wt/wt.

16. The process of claim 1 wherein the process further comprises:
(c) thickening the slurry comprising crystalline ferrous sulfate monohydrate to increase the concentration of ferrous sulfate in the slurry.

17. The process of claim 16 wherein the thickened slurry generated in step (c) has a concentration of from 20% to 40% wt/wt of ferrous sulfate monohydrate crystal.

18. The process of claim 1 wherein the method further comprises the step of:
(d1) adjusting the slurry to have a desired set of characteristics in terms of Fe concentration, acid concentration and/or water content.

19. The process of claim 18, wherein the slurry is adjusted to have a total Fe²⁺ concentration from 15% to 25% wt/wt, an acid concentration of 15% wt/wt or less and a water content of 35% wt/wt or less.

20. A process for producing ferric sulphate, which process comprises carrying out the process of claim 1 and then converting the slurry thus obtained to ferric sulphate.

21. The process of claim 1 wherein the method further comprises the following step:
(d2) separating the crystalline ferrous sulfate monohydrate out of the slurry.

22. The process of claim 21 wherein the method further comprises the step of drying and/or neutralizing the crystalline ferrous sulfate monohydrate product.

23. The process of claim 22 wherein the method comprises mixing the crystalline ferrous sulfate monohydrate product with a neutralizing agent.

24. The process of claim 23 wherein the neutralizing agent comprises limestone.

25. A process for producing ferric sulphate, which process comprises carrying out the process of claim 21 and then converting the thus obtained ferrous sulfate monohydrate product to ferric sulphate.
